(19) United States
(12) Patent Application Publication
(10) Pub. No.: US 2026/0094600 A1
(43) Pub. Date: Apr. 2, 2026

(54) Multimodal Large Language Model That Learns to Correct Itself, Focusing on Automated Speech Recognition

(71) Applicant: Google LLC, Mountain View, CA (US)

(72) Inventors: Quan Wang, Hoboken, NJ (US); Fadi Biadsy, Sandyston, NJ (US); Yonghui Xiao, Mountain View, CA (US); Youzheng Chen, Mountain View, CA (US)

(73) Assignee: Google LLC, Mountain View, CA (US)

(21) Appl. No.: 19/336,395

(22) Filed: Sep. 22, 2025

Related U.S. Application Data
(60) Provisional application No. 63/699,935, filed on Sep. 27, 2024.

(51) Int. Cl. G10L 15/16; G06F 40/284; G10L 15/06

(52) U.S. Cl. CPC G10L 15/16; G06F 40/284; G10L 15/063

(57) ABSTRACT

A method includes receiving a prompt directed towards an assistant large language model (LLM) and generating, using the assistant LLM, a sequence of output tokens based on the prompt. The sequence of output tokens includes a sequence of textual tokens including one or more correct textual tokens and one or more incorrect textual tokens, and one or more revision tokens each indicating a corresponding N number of incorrect textual tokens generated prior to the respective revision token and corresponding replacement textual tokens generated after the respective revision token for replacement of the corresponding N number of incorrect textual tokens. The method also includes generating a revised sequence of output tokens for the prompt based on the sequence of output tokens.

### CROSS-REFERENCE TO RELATED APPLICATIONS

This U.S. Patent Application claims priority under 35 U.S.C. § 119(e) to U.S. Provisional Application 63/699,935, filed on Sep. 27, 2024. The disclosure of this prior application is considered part of the disclosure of this application and is hereby incorporated by reference in its entirety.

### TECHNICAL FIELD

This disclosure relates to a multimodal large language model that learns to correct itself, focusing on automated speech recognition.

### BACKGROUND

Multimodal large language models (LLMs) are capable of handling a variety of tasks, such as performing actions and/or answering questions based on text, images, audio recordings, and/or video content. Some LLMs incorporate particular models or modules for tasks including automated speech recognition (ASR), speaker diarization, and automatic speech translation (AST). Typically, these models employ an autoregressive decoding mechanism that generates one or more output tokens at a time based on previous tokens and encoded hidden representations. However, generating output tokens autoregressively may cause the LLMs to ignore future context provided by subsequent input frames. Ignoring the future context may cause the accuracy of the LLMs to be adversely impacted.

### SUMMARY

One aspect of the disclosure provides a computer-implemented method executing on data processing hardware that causes the data processing hardware to perform operations that include receiving a prompt directed towards an assistant large language model (LLM) and generating, using the assistant LLM, a sequence of output tokens based on the prompt. The sequence of output tokens includes a sequence of textual tokens including one or more correct textual tokens and one or more incorrect textual tokens, and one or more revision tokens each indicating a corresponding N number of incorrect textual tokens generated prior to the respective revision token and corresponding replacement textual tokens generated after the respective revision token for replacement of the corresponding N number of incorrect textual tokens. The operations also include generating a revised sequence of output tokens for the prompt based on the sequence of output tokens.

This aspect may include one or more of the following optional features. In some implementations, generating the sequence of output tokens includes generating each respective output token in the sequence of output tokens autoregressively. In these implementations, generating each respective output token in the sequence of output tokens autoregressively may include conditioning the respective output token on one or more output tokens in the sequence of output tokens generated prior to the respective output token.

In some examples, the prompt includes a sequence of acoustic frames corresponding to an utterance spoken by a user and the sequence of output tokens and the revised sequence of output tokens each include a respective speech recognition result for the utterance. In other examples, the prompt includes a textual representation in a first language and the sequence of output tokens and the revised sequence of output tokens each include a respective translated textual representation in a second language different than the first language for the textual representation.

In some implementations, generating the revised sequence of output tokens includes, for each respective revision token of the one or more revision tokens: identifying the corresponding N number of incorrect textual tokens indicated by the respective revision token; and replacing the corresponding N number of incorrect textual tokens with the corresponding replacement textual tokens indicated by the respective revision token. Optionally, the operations may further include, for each respective incorrect textual token, determining, using the assistant LLM, that the respective incorrect textual token is inaccurate after generating the respective incorrect textual token based on one or more textual tokens in the sequence of textual tokens generated after the respective incorrect textual token. The corresponding N number of incorrect textual tokens may be located immediately prior to the respective revision token in the sequence of textual tokens.

In some examples, each respective revision token further indicates an offset number of textual tokens between the respective revision token and the corresponding N number of incorrect textual tokens and the corresponding N number of incorrect textual tokens are located the offset number of textual tokens away from the revision token. The assistant LLM may include an encoder-decoder architecture or the assistant LLM may include a decoder-only architecture.

In some implementations, the operations further include obtaining a plurality of training samples. Here, respective training sample includes audio data characterizing a spoken utterance and paired with a corresponding transcription. In these implementations, the operations further include augmenting the plurality of training samples by, for each corresponding transcription of each respective training sample: inserting one or more incorrect terms into the corresponding transcription; and inserting a training revision token identifying a number of the one or more incorrect terms inserted into the corresponding transcription and training replacement textual tokens for replacement of the one or more incorrect terms. In these implementations, the operations also include training the assistant LLM based on the augmented plurality of training samples.

In some examples, the operations also include obtaining a plurality of training samples each including audio data characterizing a spoken utterance and paired with a corresponding transcription, and augmenting the plurality of training samples by, for each corresponding transcription of each respective training sample: prompting an auxiliary LLM to generate a continuation output based on the corresponding transcription, appending the continuation output to the corresponding transcription; and inserting a training revision token between the corresponding transcription and the continuation output. Here, the training revision token identifies a number of terms in the continuation output appended to the corresponding transcription and training replacement textual tokens for replacement of the one or more incorrect textual tokens. In these examples, the operations also include training the assistant LLM based on the augmented plurality of training samples.

Another aspect of the disclosure provides a system that includes data processing hardware and memory hardware in communication with the data processing hardware and storing instructions that when executed on the data processing hardware causes the data processing hardware to perform operations that include receiving a prompt directed towards an assistant large language model (LLM) and generating, using the assistant LLM, a sequence of output tokens based on the prompt. The sequence of output tokens includes a sequence of textual tokens including one or more correct textual tokens and one or more incorrect textual tokens, and one or more revision tokens each indicating a corresponding N number of incorrect textual tokens generated prior to the respective revision token and corresponding replacement textual tokens generated after the respective revision token for replacement of the corresponding N number of incorrect textual tokens. The operations also include generating a revised sequence of output tokens for the prompt based on the sequence of output tokens.

This aspect may include one or more of the following optional features. In some implementations, generating the sequence of output tokens includes generating each respective output token in the sequence of output tokens autoregressively. In these implementations, generating each respective output token in the sequence of output tokens autoregressively may include conditioning the respective output token on one or more output tokens in the sequence of output tokens generated prior to the respective output token.

In some examples, the prompt includes a sequence of acoustic frames corresponding to an utterance spoken by a user and the sequence of output tokens and the revised sequence of output tokens each include a respective speech recognition result for the utterance. In other examples, the prompt includes a textual representation in a first language and the sequence of output tokens and the revised sequence of output tokens each include a respective translated textual representation in a second language different than the first language for the textual representation.

In some implementations, generating the revised sequence of output tokens includes, for each respective revision token of the one or more revision tokens: identifying the corresponding N number of incorrect textual tokens indicated by the respective revision token; and replacing the corresponding N number of incorrect textual tokens with the corresponding replacement textual tokens indicated by the respective revision token. Optionally, the operations may further include, for each respective incorrect textual token, determining, using the assistant LLM, that the respective incorrect textual token is inaccurate after generating the respective incorrect textual token based on one or more textual tokens in the sequence of textual tokens generated after the respective incorrect textual token. The corresponding N number of incorrect textual tokens may be located immediately prior to the respective revision token in the sequence of textual tokens.

In some examples, each respective revision token further indicates an offset number of textual tokens between the respective revision token and the corresponding N number of incorrect textual tokens and the corresponding N number of incorrect textual tokens are located the offset number of textual tokens away from the revision token. The assistant LLM may include an encoder-decoder architecture or the assistant LLM may include a decoder-only architecture.

In some implementations, the operations further include obtaining a plurality of training samples. Here, respective training sample includes audio data characterizing a spoken utterance and paired with a corresponding transcription. In these implementations, the operations further include augmenting the plurality of training samples by, for each corresponding transcription of each respective training sample: inserting one or more incorrect terms into the corresponding transcription; and inserting a training revision token identifying a number of the one or more incorrect terms inserted into the corresponding transcription and training replacement textual tokens for replacement of the one or more incorrect terms. In these implementations, the operations also include training the assistant LLM based on the augmented plurality of training samples.

In some examples, the operations also include obtaining a plurality of training samples each including audio data characterizing a spoken utterance and paired with a corresponding transcription, and augmenting the plurality of training samples by, for each corresponding transcription of each respective training sample: prompting an auxiliary LLM to generate a continuation output based on the corresponding transcription; appending the continuation output to the corresponding transcription, and inserting a training revision token between the corresponding transcription and the continuation output. Here, the training revision token identifies a number of terms in the continuation output appended to the corresponding transcription and training replacement textual tokens for replacement of the one or more incorrect textual tokens. In these examples, the operations also include training the assistant LLM based on the augmented plurality of training samples.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1A and 1B are schematic views of an example digital assistant system.

FIG. 2 is a schematic view of an example training data generation process.

FIG. 3 is a schematic view of an example training process for training an assistant large language model.

FIG. 4 is a flowchart of an example arrangement of operations for a computer-implemented method of an assistant large language model that corrects itself.

FIG. 5 is a schematic view of an example computing device that may be used to implement the systems and methods described herein.

Like reference symbols in the various drawings indicate like elements.

### DETAILED DESCRIPTION

Multimodal large language models (LLMs) are capable of handling a variety of tasks, such as performing actions and/or answering questions based on text, images, audio recordings, and/or video content. Some LLMs incorporate particular models or modules for tasks including automated speech recognition (ASR), speaker diarization, and automatic speech translation (AST). Typically, these models employ an autoregressive decoding mechanism that generates one or more output tokens at a time based on previous tokens and encoded hidden representations.

A significant drawback of autoregressive decoding is the inability to revise past predictions. That is, once a particular token is selected or output at a specific output step, all future predictions of output tokens are conditioned on the particular token even if the particular token later proves to be incorrectly recognized. Thus, the inability to revise past predictions with autoregressive decoding can lead to cascading errors in generating subsequent output tokens which may contribute to issues such as hallucinations and other misrecognition behaviors. For instance, in ASR tasks, hallucinations can manifest as repeated words or phrases, incorrect additions, or even responses that were not present in the input audio.

Existing approaches to mitigate hallucination and other misrecognition errors include improved loss functions and augmented training data to train these models. Yet, these approaches fail to ever teach these models how to recognize and correct such errors once they occur. The failure to correct these errors is especially problematic for streaming models, such as those offering streaming ASR, speech translation, and machine translation, which generate outputs based on incrementally received or otherwise incomplete information. That is, streaming models may not have the benefit of processing future acoustic frames to determine the most accurate results since streaming models favor minimal latency over accuracy. As such, streaming models may initially output partially incorrect results to minimize latency and be unable to correct past incorrect predictions due to the nature of autoregressive decoding.

Accordingly, implementations herein are directed towards an assistant large language model (LLM) with self-correction. As will become apparent, the assistant LLM may operate autoregressively and perform speech-related tasks such as automatic speech recognition, speech translation, and/or machine translation. The assistant LLM receives a prompt and generates a sequence of output tokens based on the prompt. For example, the prompt may include a sequence of acoustic frames corresponding to a spoken utterance whereby the sequence of output tokens generated by the assistant LLM includes a speech recognition result for the spoken utterance. In another example, the prompt may include a textual representation in a first language whereby the sequence of output tokens generated by the assistant LLM includes a translated textual representation in a second language. The sequence of output tokens includes a sequence of textual tokens and one or more revision tokens. The sequence of textual tokens includes one or more correct textual tokens and one or more incorrect textual tokens. Each respective revision token indicates a corresponding N number of incorrect textual tokens generated prior to the respective revision token and corresponding replacement textual tokens generated after the respective revision token for replacement of the corresponding N number of incorrect textual tokens. Thereafter, an output layer generates a revised sequence of output tokens for the prompt based on the sequence of output tokens. In some examples, the output layer may be integrated with the assistant LLM such that the assistant LLM generates the revised sequence of output tokens using the output layer. In other examples, the output layer is external from the assistant LLM such that the assistant LLM transmits the sequence of output tokens to the output layer causing the output layer to generate the revised sequence of tokens. For instance, the output layer may reside at a downstream application of a user device.

As such, generating the one or more revision tokens enables the assistant LLM to revise past predictions after processing subsequent acoustic frames while operating autoregressively. That is, the revision tokens indicate that one or more of the predicted textual tokens are incorrect and one or more replacement textual tokens to replace the incorrect predictions. Thus, the revision tokens allow models to revise previous predictions while still generating the sequence of output tokens in an autoregressive manner. The revision of previous predictions may be applied to models that operate in a streaming fashion, a non-streaming fashion, or some combination thereof. Advantageously, this enables the assistant LLM to operate in a streaming manner to reduce latency and benefit from the additional context from future acoustic frames.

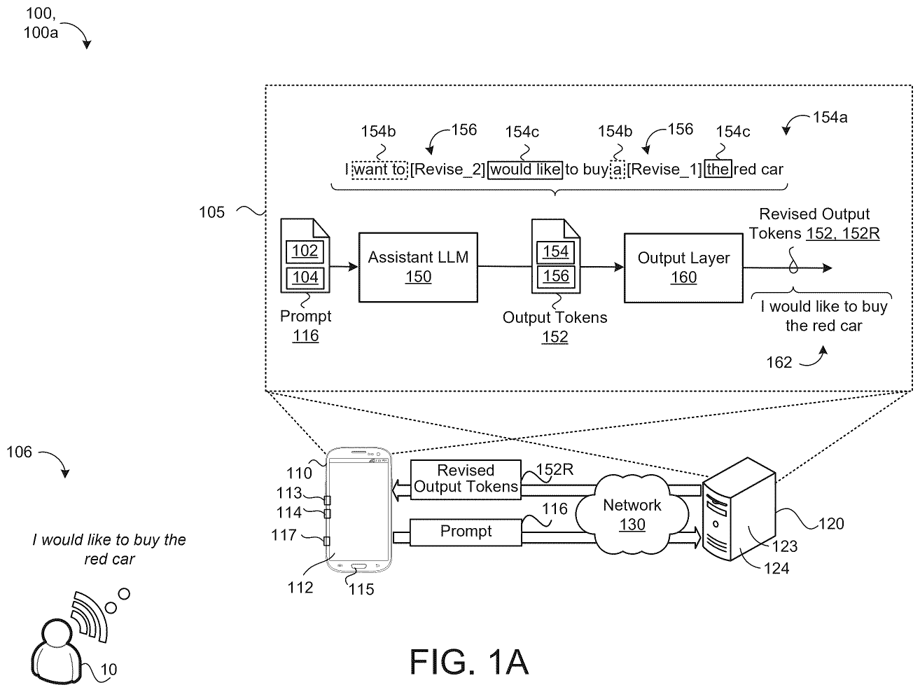

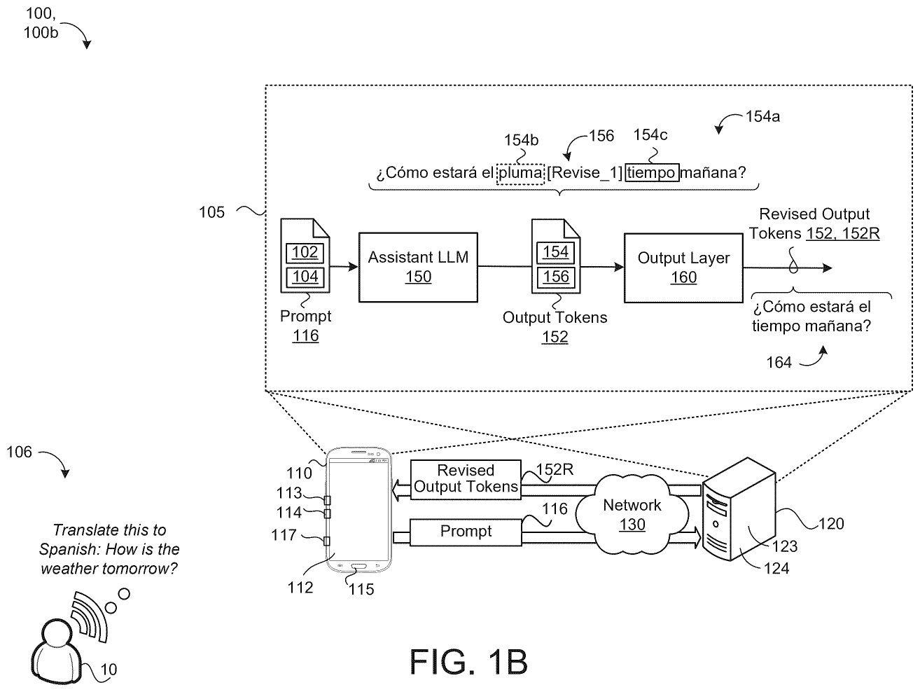

FIG. 1 shows an example system 100 including a digital assistant system 105. Generally, the user 10 inputs, via a user device 110, a prompt 116 directed towards an assistant large language model (LLM) 150. In some examples, the prompt 116 may specify an action for the assistant LLM 150 to perform. As will become apparent, the assistant LLM 150 generates a sequence of output tokens 152 based on processing the prompt 116. In some examples, the user 10 speaks an utterance 106 or natural language query that serves as the prompt 116 input to the assistant LLM 150. The prompt 116 may include audio data 102 of the natural language query or utterance 106 that the user 10 speaks. Additionally or alternatively, the prompt 116 may include a textual representation 104 of a natural language query or utterance that the user 10 provides as a textual input (e.g., via keyboard or graphical user interface). The assistant LLM 150 may be a multimodal LLM configured to process different types of inputs and outputs, such as audio, text, videos, and/or images. Thus, depending on the type and content of the prompt 116, the assistant LLM 150 may perform different tasks by processing the prompt 116.

For instance, if the prompt 116 includes the audio data 102 of an utterance 106 spoken by the user 10, the assistant LLM 150 may perform automatic speech recognition (ASR) on the audio data 102 to produce a speech recognition result (i.e., transcription) of the spoken utterance 106. The utterances 106 spoken by the user 10 may include voice commands, such as queries for the assistant LLM 150 to respond to or commands requesting the assistant LLM 150 to perform a particular action. For example, the query may include “what is the weather today” which the assistant LLM 150 responds to with an answer about the weather, or the command may include “schedule a meeting for tomorrow” which the assistant LLM 150 performs the action of scheduling the meeting. In another example, the prompt 116 may include audio data 102 of an utterance 106 spoken by the user 10 in a first language and a request (e.g., spoken by the user 10 or provided as a textual input) to translate the utterance 106 into a second language such that the assistant LLM 150 performs automatic speech translation (AST) on the utterance 106 to generate synthetic speech in the second language. Here, the synthetic speech in the second language is a translation of the utterance 106 spoken by the user 10 in the first language. In yet another example, the prompt 116 may include a textual representation 104 input by the user 10 in a first language and a request to translate the textual representation 104 into a second language such that the assistant LLM 150 performs machine translation on the textual representation to generate a translation of the textual representation 104 in the second language. The textual representation 104 may be provided as text by the user 10 or may be a transcription of an utterance 106 spoken by the user 10.

In some examples, the assistant LLM 150 includes an encoder-decoder architecture. For example, the assistant LLM 150 may include a recurrent neural network-transducer (RNN-T) architecture. Here, the encoder of the assistant LLM 150 generates encodings based on the prompt 116 and the decoder of the assistant LLM 150 decodes the encodings to produce an output. The encoder may include a stack of multi-head self-attention layers (e.g., Conformer or transformer layers). In other examples, the assistant LLM 150 includes a decoder-only architecture. In these examples, the assistant LLM 150 omits the encoder such that the decoder of the assistant LLM 150 processes the prompt 116 directly to produce the outputs. In some examples, a speech model is used in lieu of the assistant LLM 150 (not shown). For instance, a speech recognition model may process the audio data 102 of an utterance 106 to produce a speech recognition result of the utterance or a translation model may process the textual representation 104 to produce a translation of the textual representation 104.

The system includes the user device 110, a remote computing system 120, and a network 130. The user device 110 includes data processing hardware 113 and memory hardware 114. The user device 110 may include, or be in communication with an audio capture device 115 (e.g., an array of one or more microphones) for converting utterances 106 or natural language queries spoken by the user 10 into corresponding audio data (e.g., sequence of acoustic frames) 102. In addition to, or in lieu of, spoken input, the user 10 may input a textual representation 104 of the natural language query via a user interface executing on the user device 110.

The user device 110 may be any computing device capable of communicating with the remote computing system 120 through the network 130. The user device 110 includes, but is not limited to, desktop computing devices and mobile computing devices, such as laptops, tablets, smart phones, smart speakers/displays, digital assistant devices, smart appliances, internet-of-things (IoT) devices, infotainment systems, vehicle infotainment systems, and wearable computing devices (e.g., headsets, smart glasses, and/or watches). The remote computing system 120 may be a distributed system (e.g., cloud computing environment) having scalable elastic resources. The resources include computing resources 123 (e.g., data processing hardware) and/or storage resources 124 (e.g., memory hardware). Additionally or alternatively, the remote computing system 120 may be a centralized system. The network 130 may be wired, wireless, or a combination thereof, and may include private networks and/or public networks, such as the Internet.

The assistant LLM 150 is configured to process the prompt 116 to generate the sequence of output tokens 152. In some configurations, the assistant LLM 150 is a streaming model that operates autoregressively. More specifically, the assistant LLM 150 includes a decoder that, at each of a plurality of output steps, generates a corresponding output token 152 that is conditioned on previously generated output tokens 152. That is, the assistant LLM 150 predicts the next output token 152 in the sequence of output tokens 152 based on the output tokens 152 produced before the next output token 152. Thus, each output token 152 is generated one at a time, with each new output token 152 being conditioned on the previously generated output tokens. Put another way, at each of a plurality of output steps, the assistant LLM 150 generates a corresponding output token 152 or a respective acoustic frame 102 in the sequence of acoustic frames 102. Consequently, when generating each new output token 152, the assistant LLM 150 may not benefit from any context provided by subsequent output tokens 152. Here, context may refer to linguistic context that provides additional information to help disambiguate words and phrases. Thus, linguistic context may help the assistant LLM 150 anticipate upcoming words such that the assistant LLM can more accurately predict and interpret the current input, especially in cases where homophones or ambiguous phrases are involved. As such, the linguistic context allows the system to better understand the overall meaning and intent of the speech, leading to more accurate transcriptions. As will become apparent, future context can help in correcting errors by re-evaluating previous words in light of new information.

The sequence of output tokens 152 includes a sequence of textual tokens 154 and one or more revision tokens 156. Each textual token 154 in the sequence of textual tokens 154 includes a textual unit, such as a word, word piece, grapheme, etc. The sequence of textual tokens includes 154 one or more correct textual tokens 154, 154a and one or more incorrect textual tokens 154, 154b. Correct textual tokens 154a represent accurately generated textual tokens 154 in light of subsequently generated textual tokens 154. Each correct textual token 154a is a textual token 154 initially generated by the assistant LLM 150 that correctly corresponds to the prompt 116. That is, the correct textual token 154a represents an accurately generated textual token 154 that is not subsequently replaced by another textual token. For example, a correct textual token 154a in the speech recognition context refers to a textual token 154 that accurately corresponds to the utterance 106. In another example, a correct textual token 154a in the machine translation context refers to a textual token 154 that accurately corresponds to a translation of the textual representation 104.

On the other hand, incorrect textual tokens 154b represent inaccurately generated textual tokens 154 in light of subsequently generated textual tokens 154. That is, the incorrect textual token 154b represents an inaccurately generated textual token 154 that may be subsequently replaced by another textual token. For example, an incorrect textual token 154b in the speech recognition context refers to a textual token 154 that inaccurately corresponds to the utterance 106. In another example, an incorrect textual token 154b in the machine translation context refers to a textual token 154 that inaccurately corresponds to a translation of the textual representation 104.

When the assistant LLM 150 operates autoregressively, the assistant LLM 150 may generate a respective textual token 154 conditioned on previously generated textual tokens 154 such that the assistant LLM 150 believes the respective textual token 154 to be correct based on the previously generated textual tokens 154. Thereafter, the assistant LLM 150 generates one or more textual tokens 154 after the respective textual token 154 thereby providing further context to the assistant LLM 150. Thus, based on the additional context provided by the one or more textual tokens 154 generated after the respective textual token 154, the assistant LLM 150 may no longer believe that the respective textual token 154 that was previously generated is correct.

To that end, the sequence of output tokens 152 may include one or more revision tokens 156. Each respective revision token 156 identifies a corresponding N number of incorrect textual tokens 154b generated prior to the respective revision token 156 and corresponding replacement textual tokens 154, 154c generated after the respective revision token 156 for replacement of the corresponding N number of incorrect textual tokens 154b. Simply put, each revision token 156 indicates that the assistant LLM 150 determined one or more of the previously output textual tokens 154 is incorrect in light of additional context and further indicates the corresponding replacement textual tokens 154c that should replace the incorrect textual tokens 154b. The N number of incorrect textual tokens 154b identified by each revision token 156 may indicate all incorrect textual tokens 154 generated prior to the respective revision token 156 but after the revision token 156 prior to the respective revision token 156. For example, a second revision token 156 in the sequence of output tokens 152 may indicate all incorrect textual tokens 154b generated prior to the second revision token 156 but after a first revision token 156.

In some implementations, the N number of incorrect textual tokens 154b identified by the respective revision token 156 are located immediately prior to the respective revision token 156. For instance, a revision token 156 may identify three incorrect textual tokens 154b generated prior to the revision token 156 whereby the three incorrect textual tokens 154b include the three immediately prior textual tokens 154 with respect to the revision token 156. In other implementations, the N number of incorrect textual tokens 154b identified by each respective revision token 156 are located an offset number of output tokens 152 away from the respective revision token 156. For example, a revision token 156 may identify three incorrect textual tokens 154b generated prior to the revision token 156 whereby one or more correct textual tokens 154a are located between the revision token 156 and the three incorrect textual tokens 154b.

FIG. 1A shows a first example system 100, 100a with the prompt 116 including audio data (e.g., the sequence of acoustic frames) 102 corresponding to an utterance 106 spoken by the user 10 of “I would like to buy the red car” whereby the assistant LLM 150 aims to generate a speech recognition result 162 that corresponds to the utterance 106. As such, the assistant LLM 150 processes the audio data 102 of the prompt 116 to generate the sequence of output tokens 152 corresponding to “I want to [Revise_2] would like to buy a [Revise_1] the red car” based on processing the sequence of acoustic frames 102. Here, the textual tokens 154 corresponding to “I,” “to buy,” and “red car” represent correct textual tokens 154a. The textual tokens 154 corresponding to “want to” and “a” represent incorrect textual tokens 154b and are denoted by the dashed boxes. The incorrect textual tokens 154b represent textual tokens 154 the assistant LLM 150 believed to be accurate at the corresponding output step when they were generated, but thereafter the assistant LLM 150 believes they are inaccurate based on subsequently generated textual tokens 154 that provide additional context. Moreover, “[Revise_2]” represents a revision token 156 for replacing the two prior incorrect textual tokens 154b of “want to” with the replacement textual tokens 154c of “would like,” and “[Revise_1]” represents a revision token 156 to replace the one prior incorrect textual token 154b of “a” with the replacement textual token 154c of “the.” Here, the replacement textual tokens 154c are denoted by the solid boxes.

The output layer 160 is configured to process the sequence of output tokens 152 to generate a revised sequence of output tokens 152, 152R which may include revised speech recognition results 162 for the utterance 106. Put another way, the output layer 160 is configured to make one or more revisions (if any) to the sequence of output tokens 152 based on the presence of revision tokens 156. More specifically, for each respective revision token 156 of the one or more revision tokens 156, the output layer 160 identifies the corresponding N number of incorrect textual tokens 154b indicated by the respective revision token 156 and replaces the corresponding N number of incorrect textual tokens 154b with the corresponding replacement textual token 154c indicated by the respective revision token 156. Thus, the speech recognition result 162 generated by the output layer 160 includes the one or more correct textual tokens 154a from the sequence of output tokens 152 and excludes the one or more incorrect textual tokens 154b that are replaced by the corresponding replacement textual tokens 154c.

Continuing with the example shown, the output layer 160 receives the sequence of output tokens 152 corresponding to “I want to [Revise 2] would like to buy a [Revise_1] the red car” and generates the revised sequence of output tokens 152R including the revised speech recognition result 162 of “I would like to buy the red car.” Notably, based on the “[Revise_2]” revision token 156, the output layer 160 replaces the incorrect textual tokens 154b of “want to” with the corresponding replacement textual tokens 154c of “would like” and replaces the incorrect textual token 154b of “a” with the corresponding replacement token 154c of “the.”

FIG. 1B shows a second example system 100, 100b with the prompt 116 including audio data (e.g., the sequence of acoustic frames) 102 corresponding to an utterance 106 spoken by the user 10 of “Translate this to Spanish: How is the weather tomorrow?” Here, the assistant LLM 150 processes a textual representation 104 of the utterance 106 “How is the weather tomorrow?” The textual representation 104 may be transcribed based on a spoken speech input or directly provided by the user 10 as a textual representation 104. As such, in this example, the assistant LLM 150 aims to translate the phrase “How is the weather tomorrow?” from English to Spanish. To that end, the assistant LLM 150 processes the textual representation 104 of the prompt 116 to generate the sequence of output tokens 152 corresponding to “¿Cómo estará el pluma [Revise_1] tiempo mañana?” Here, the textual tokens 154 corresponding to “I,” “to buy,” and “red car” represent correct textual tokens 154a. The textual token 154 corresponding to “pluma” represents an incorrect textual token 154b and is denoted by the dashed box. The incorrect textual token 154b represents a textual token 154 the assistant LLM 150 believed to be accurate at the corresponding output step when it was generated, but thereafter the assistant LLM 150 believes they are inaccurate based on subsequently generated textual tokens 154 that provide additional context. Moreover, “[Revise_1]” represents a revision token 156 for replacing one prior incorrect textual token 154b of “pluma” with the replacement textual token 154c of “tiempo.” Here, the replacement textual tokens 154c are denoted by the solid boxes.

The output layer 160 is configured to process the sequence of output tokens 152 to generate a revised sequence of output tokens 152, 152R which may include a revised translated textual representation 164 for the textual representation 104. Put another way, the output layer 160 is configured to make one or more revisions (if any) to the sequence of output tokens 152 based on the presence of revision tokens 156. More specifically, for each respective revision token 156 of the one or more revision tokens 156, the output layer 160 identifies the corresponding N number of incorrect textual tokens 154b indicated by the respective revision token 156 and replaces the corresponding N number of incorrect textual tokens 154b with the corresponding replacement textual token 154c indicated by the respective revision token 156. Thus, the revised translated textual representation 164 generated by the output layer 160 includes the one or more correct textual tokens 154a from the sequence of output tokens 152 and excludes the one or more incorrect textual tokens 154b that are replaced by the corresponding replacement textual tokens 154c.

Continuing with the example shown, the output layer 160 receives the sequence of output tokens 152 corresponding to “¿Cómo estará el pluma [Revise_1] tiempo mañana?” and generates the revised sequence of output tokens 152R including the revised translated textual representation 164 of “¿Cómo estará el tiempo mañana?” I would like to buy the red car.” Notably, based on the “[Revise_1]” revision token 156, the output layer 160 replaces the incorrect textual tokens 154b of “pluma” with the corresponding replacement textual tokens 154c of “tiempo.”

The assistant LLM 150 determines, at each output step of the plurality of output steps, whether to output a next textual token 154 in the sequence of textual tokens 154 or output a revision token 156. That is, at each output step, the assistant LLM 150 may determine whether any of the past textual tokens 154 are incorrect based on subsequently generated output tokens 152. When the assistant LLM 150 determines one or more of the past textual tokens 154 are incorrect at a corresponding output step, the assistant LLM 150 generates a revision token 156 instead of a textual token 154 at the corresponding output step. On the other hand, when the assistant LLM 150 does not determine one or more of the past textual tokens 154 are incorrect at a corresponding output step, the assistant LLM 150 outputs another textual token 154 at the corresponding output step.

In some implementations, the output layer 160 is integrated with the assistant LLM 150 such that the output produced by the output layer 160 represents the output of the assistant LLM 150. Here, the assistant LLM 150 generates the revised sequence of output tokens 152R using the output layer 160. In other implementations, the output layer 160 is external from the assistant LLM 150 and resides at one or more downstream applications of the user device 110. Here, the assistant LLM 150 may transmit the sequence of output tokens 152 to the output layer 160 which causes the output layer 160 to generate the revised sequence of output tokens 152R based on the sequence of output tokens 152.

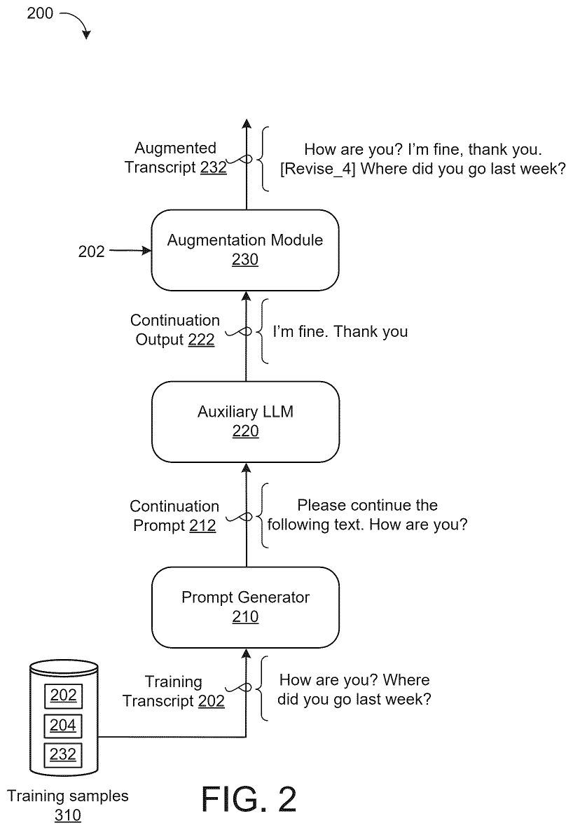

FIG. 2 illustrates a training data generation process 200. In some instances, the assistant LLM 150 is susceptible to a continuation error when performing ASR. The assistant LLM 150 may be trained or finetuned on a corpus of text-only training examples such that the assistant LLM 150 learns to predict the next likely text token based on previously generated text tokens. As such, the assistant LLM 150 may inadvertently predict continuation text tokens 154 that are likely continuations of previously generated text tokens even though the audio data 102 does not include such continuation. For example, during training on the text-only training examples the assistant LLM 150 may learn that a likely text sequence includes “How are you? I'm fine, thank you.” Thus, the assistant LLM 150 may incorrectly predict the speech recognition result of “How are you? I'm fine, thank you. Where did you go last week?” when processing the utterance 106 “How are you? Where did you go last week?” That is, the assistant LLM 150 may incorrectly assume that the phrase “I'm fine, thank you” is present in the utterance 106 due to the text-only training portion even though no such phrase was spoken.

To that end, the training data generation process 200 is configured to generate a plurality of augmented training transcripts 232 to train the assistant LLM 150 on. The training data generation process 200 obtains a plurality of training samples 310. Each respective training sample 310 includes audio data 204 characterizing a spoken utterance and is paired with a corresponding transcription (i.e., training transcript) 202. The training data generation process includes a prompt generator 210 that receives a plurality of training transcripts 202. The training transcripts 202 include text-only data that optionally may be paired with corresponding audio data. For each training transcript 202, the prompt generator 210 generates a corresponding continuation prompt 212. The continuation prompt 212 may request a likely text continuation for the training transcript 202 or some portion thereof. As such, the prompt generator 210 may generate the continuation prompt 212 by extracting a portion of the training transcript 202 and generating the continuation prompt 212 based on the extracted portion. For example, for the training transcript 202 of “How are you? Where did you go last week?” the prompt generator 210 may extract “How are you?” and generate the continuation prompt 212 of “Please continue the following text. How are you?”

Thereafter, an auxiliary LLM 220, distinct from the assistant LLM 150, receives the continuation prompt 212 and generates a continuation output 222 based on the continuation prompt 212. The continuation output 222 represents a likely text continuation that would follow the training transcript 202 or the extracted portion of the training transcript 202. Continuing with the above example, the auxiliary LLM 220 may generate the continuation output 222 of “I'm fine, thank you” for the continuation prompt 212 which represents a likely textual continuation that follows “How are you?” Finally, an augmentation module 230 generates the augmented training transcript 232 based on the training transcript 202 and the corresponding continuation output 222 generated by the auxiliary LLM 220. In particular, the augmentation module 230 may insert or append the continuation output 222 into the training transcript 202 and a corresponding revision token 156. That is, since the continuation output 222 inserted into the training transcript 202 represents a simulated error, the augmentation module 230 also inserts the revision token 156 to indicate that the continuation output 222 should be deleted.

Continuing with the example shown, the augmentation module 230 generates the augmented training transcript 232 of “How are you? I'm fine, thank you. [Revise_4] Where did you go last week?” Here, the augmentation module 230 inserted the continuation output 222 of “I'm fine, thank you.” after “How are you?” and inserted the revision token 156 of “[Revise_4]” after the continuation output 222 to indicate that “I'm fine, thank you.” should be deleted. Notably, the revision token 156 simply indicates that “I'm fine, thank you” should be deleted without any replacement textual tokens 154c.

In some implementations, the training transcript 202 includes a ground-truth transcript and a misrecognized transcript. For example, the training transcript 202 may include the ground-truth transcript of “How are you doing today?” (e.g., the correct transcription) and the misrecognized transcript of “How are you doing um um?” Here, the augmentation module 230 may receive the training transcript 202 directly and generate the augmented training transcript 232 based on the ground-truth transcript and a misrecognized transcript. For instance, with respect to the example above, the augmentation module 230 may generate the augmented training transcript 232 of “How are you doing um um? [Revise_2] today?”

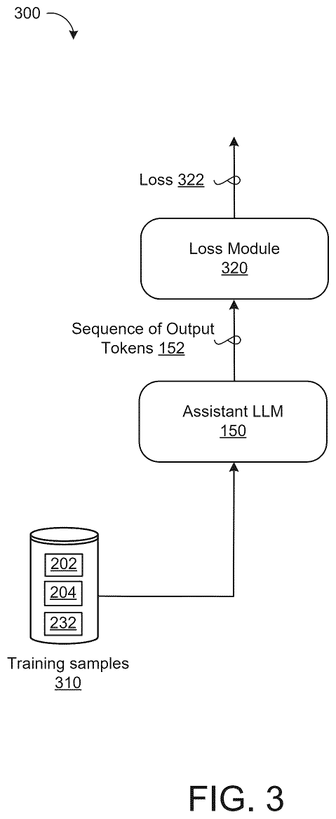

FIG. 3 shows a training process 300 for training the assistant LLM 150. The training process 300 obtains the plurality of training samples 310. Each respective training sample includes audio data 204 characterizing a spoken utterance and is paired with a corresponding transcription (i.e., training transcript) 202. Each transcription 202 may be augmented by the training data generation process 200 (FIG. 2) such that each training sample 310 further includes a corresponding augmented training transcript 232 which serves as a ground-truth transcription. For each training sample 310 of the plurality of training samples 310, the assistant LLM 150 generates a corresponding sequence of output tokens 152 based on the audio data 204 or training transcript 202 of the respective training sample 310. For instance, the assistant LLM 150 may generate the sequence of output tokens 152 that represents a transcription of the audio data 204 or a translated textual representation of the training transcript 202. The sequence of output tokens 152 may include a sequence of text tokens 154 and one or more revision tokens 156.

Thereafter, a loss module 320 receives the sequence of output tokens 152 generated for each respective training sample 310 and determines a loss 322 by comparing the sequence of output tokens 152 with the corresponding augmented training transcript 232. The training process 300 may train the assistant LLM 150 based on the loss 322 determined for each training sample 310 of the plurality of training samples. In some implementations, the assistant LLM 150 determines an N-best list of sequence of output tokens 152 for each training sample 310. For example, the assistant LLM 150 may determines ten sequences of output tokens 152 for each training sample. Here, the loss module 320 determines the loss 322 by comparing each sequence of output tokens 152 from the N-best list of sequence of output tokens 152 to the augmented training sample 232 to determine the loss 322.

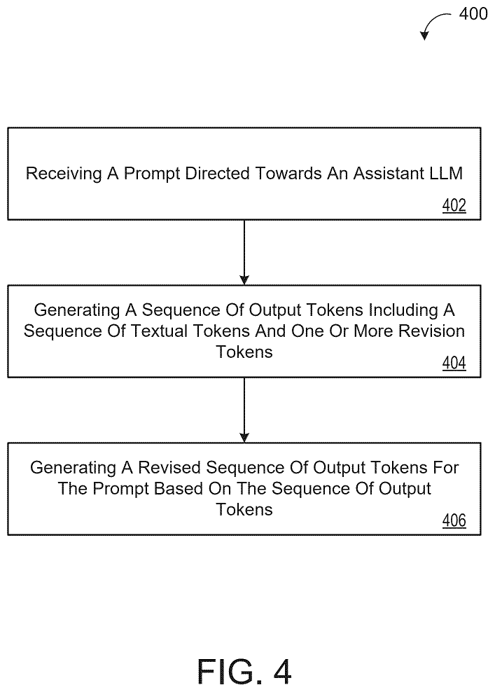

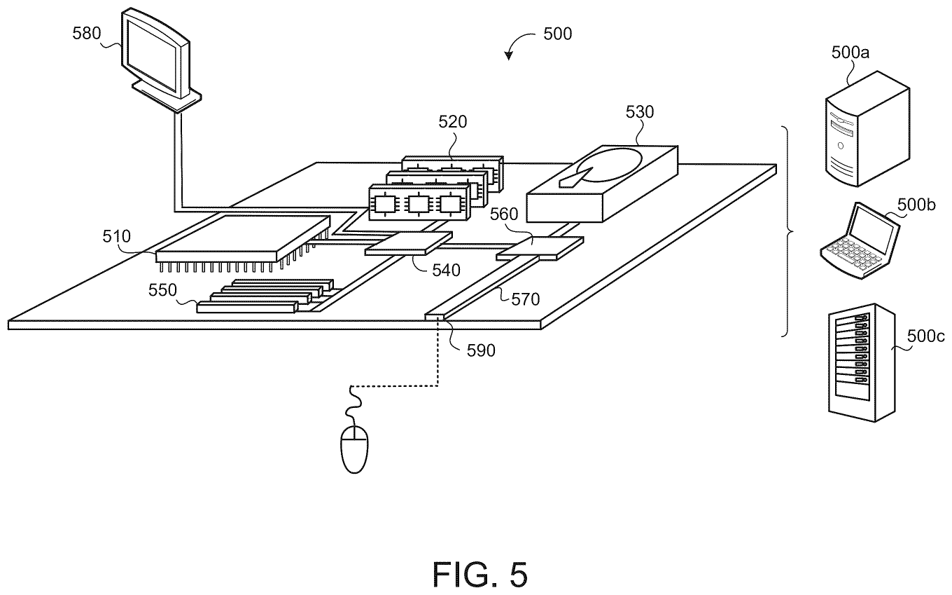

FIG. 4 is flowchart of an example arrangement of operations for a computer-implemented method 400 of using an assistant LLM 150 with self-correction. The method 400 may execute on data processing hardware 510 (FIG. 5) based on instructions stored on memory hardware 520 (FIG. 5). In some examples, the data processing hardware 510 includes data processing hardware 113 of the user device 110 and the memory hardware 520 includes the memory hardware 114 of the user device 110. In other examples, the data processing hardware 510 includes the data processing hardware 123 of the remote computing system 120 and the memory hardware 520 includes the data processing hardware 124 of the remote computing system 120.

At operation 402, the method 400 includes receiving a prompt 116 directed towards the assistant LLM 150. At operation 404, the method 400 includes generating a sequence of output tokens 152 based on the prompt 116 using the assistant LLM 150. The sequence of output tokens 152 may include a speech recognition result when the prompt 116 includes a sequence of acoustic frames 102 corresponding to an utterance 106 spoken by a user. Alternatively, the sequence of output tokens 152 may include a translated textual representation in a translated language when the prompt 116 includes textual representation 104 in a source language. The sequence of output tokens 152 includes a sequence of textual tokens 154 and one or more revision tokens 156. The sequence of textual tokens 154 includes one or more correct textual tokens 154a and one or more incorrect textual tokens 154b. Each respective revision token indicates a corresponding N number of incorrect textual tokens 154b generated prior to the respective revision token 156 and corresponding replacement textual tokens 154c generated after the respective revision token 156 for replacement of the corresponding N number of incorrect textual tokens 154b. At operation 406, the method 400 includes generating a revised sequence of output tokens 152R for the prompt based on the sequence of output tokens 152. The revised sequence of output tokens 152 may include a revised speech recognition result 162 when the assistant LLM 150 performs speech recognition or a revised translated textual representation 164 when the assistant LLM 150 performs machine translation.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving a prompt directed towards an assistant large language model (LLM);
generating, using the assistant LLM, a sequence of output tokens based on the prompt, the sequence of output tokens comprising:
a sequence of textual tokens comprising one or more correct textual tokens and one or more incorrect textual tokens; and
one or more revision tokens, each respective revision token indicating a corresponding N number of incorrect textual tokens generated prior to the respective revision token and corresponding replacement textual tokens generated after the respective revision token for replacement of the corresponding N number of incorrect textual tokens; and
generating a revised sequence of output tokens for the prompt based on the sequence of output tokens.

2. The computer-implemented method of claim 1, wherein generating the sequence of output tokens comprises generating each respective output token in the sequence of output tokens autoregressively.

3. The computer-implemented method of claim 2, wherein generating each respective output token in the sequence of output tokens autoregressively comprises conditioning the respective output token on one or more output tokens in the sequence of output tokens generated prior to the respective output token.

4. The computer-implemented method of claim 1, wherein:
the prompt comprises a sequence of acoustic frames corresponding to an utterance spoken by a user; and
the sequence of output tokens and the revised sequence of output tokens each comprise a respective speech recognition result for the utterance.

5. The computer-implemented method of claim 1, wherein:
the prompt comprises a textual representation in a first language; and
the sequence of output tokens and the revised sequence of output tokens each comprise a respective translated textual representation in a second language different than the first language for the textual representation.

6. The computer-implemented method of claim 1, wherein generating the revised sequence of output tokens comprises, for each respective revision token of the one or more revision tokens:
identifying the corresponding N number of incorrect textual tokens indicated by the respective revision token, and
replacing the corresponding N number of incorrect textual tokens with the corresponding replacement textual tokens indicated by the respective revision token.

7. The computer-implemented method of claim 1, wherein the operations further comprise, for each respective incorrect textual token, determining, using the assistant LLM, that the respective incorrect textual token is inaccurate after generating the respective incorrect textual token based on one or more textual tokens in the sequence of textual tokens generated after the respective incorrect textual token.

8. The computer-implemented method of claim 1, wherein the corresponding N number of incorrect textual tokens are located immediately prior to the respective revision token in the sequence of textual tokens.

9. The computer-implemented method of claim 1, wherein:
each respective revision token further indicates an offset number of textual tokens between the respective revision token and the corresponding N number of incorrect textual tokens; and
the corresponding N number of incorrect textual tokens are located the offset number of textual tokens away from the revision token.

10. The computer-implemented method of claim 1, wherein the assistant LLM comprises an encoder-decoder architecture.

11. The computer-implemented method of claim 1, wherein the assistant LLM comprises a decoder-only architecture.

12. The computer-implemented method of claim 1, wherein the operations further comprise:
obtaining a plurality of training samples, each respective training sample comprising audio data characterizing a spoken utterance and paired with a corresponding transcription;
augmenting the plurality of training samples by, for each corresponding transcription of each respective training sample:
inserting one or more incorrect terms into the corresponding transcription; and
inserting a training revision token identifying a number of the one or more incorrect terms inserted into the corresponding transcription and training replacement textual tokens for replacement of the one or more incorrect terms, and
training the assistant LLM based on the augmented plurality of training samples.

13. The computer-implemented method of claim 1, wherein the operations further comprise:
obtaining a plurality of training samples, each respective training sample comprising audio data characterizing a spoken utterance and paired with a corresponding transcription;
augmenting the plurality of training samples by, for each corresponding transcription of each respective training sample:
prompting an auxiliary LLM to generate a continuation output based on the corresponding transcription;
appending the continuation output to the corresponding transcription; and
inserting a training revision token between the corresponding transcription and the continuation output, the training revision token identifying a number of terms in the continuation output appended to the corresponding transcription and training replacement textual tokens for replacement of the one or more incorrect textual tokens; and
training the assistant LLM based on the augmented plurality of training samples.

14. A system comprising:
data processing hardware; and
memory hardware in communication with the data processing hardware, the memory hardware storing instructions that when executed on the data processing hardware cause the data processing hardware to perform operations comprising:
receiving a prompt directed towards an assistant large language model (LLM);
generating, using the assistant LLM, a sequence of output tokens based on the prompt, the sequence of output tokens comprising:
a sequence of textual tokens comprising one or more correct textual tokens and one or more incorrect textual tokens; and
one or more revision tokens, each respective revision token indicating a corresponding N number of incorrect textual tokens generated prior to the respective revision token and corresponding replacement textual tokens generated after the respective revision token for replacement of the corresponding N number of incorrect textual tokens; and
generating a revised sequence of output tokens for the prompt based on the sequence of output tokens.

15. The system of claim 14, wherein generating the sequence of output tokens comprises generating each respective output token in the sequence of output tokens autoregressively.

16. The system of claim 15, wherein generating each respective output token in the sequence of output tokens autoregressively comprises conditioning the respective output token on one or more output tokens in the sequence of output tokens generated prior to the respective output token.

17. The system of claim 14, wherein:
the prompt comprises a sequence of acoustic frames corresponding to an utterance spoken by a user; and
the sequence of output tokens and the revised sequence of output tokens each comprise a respective speech recognition result for the utterance.

18. The system of claim 14, wherein:
the prompt comprises a textual representation in a first language; and
the sequence of output tokens and the revised sequence of output tokens each comprise a respective translated textual representation in a second language different than the first language for the textual representation.

19. The system of claim 14, wherein generating the revised sequence of output tokens comprises, for each respective revision token of the one or more revision tokens:
identifying the corresponding N number of incorrect textual tokens indicated by the respective revision token; and
replacing the corresponding N number of incorrect textual tokens with the corresponding replacement textual tokens indicated by the respective revision token.

20. The system of claim 14, wherein the operations further comprise, for each respective incorrect textual token, determining, using the assistant LLM, that the respective incorrect textual token is inaccurate after generating the respective incorrect textual token based on one or more textual tokens in the sequence of textual tokens generated after the respective incorrect textual token.

21. The system of claim 14, wherein the corresponding N number of incorrect textual tokens are located immediately prior to the respective revision token in the sequence of textual tokens.

22. The system of claim 14, wherein:
each respective revision token further indicates an offset number of textual tokens between the respective revision token and the corresponding N number of incorrect textual tokens; and
the corresponding N number of incorrect textual tokens are located the offset number of textual tokens away from the revision token.

23. The system of claim 14, wherein the assistant LLM comprises an encoder-decoder architecture.

24. The system of claim 14, wherein the assistant LLM comprises a decoder-only architecture.

25. The system of claim 14, wherein the operations further comprise:
obtaining a plurality of training samples, each respective training sample comprising audio data characterizing a spoken utterance and paired with a corresponding transcription,
augmenting the plurality of training samples by, for each corresponding transcription of each respective training sample:
inserting one or more incorrect terms into the corresponding transcription; and
inserting a training revision token identifying a number of the one or more incorrect terms inserted into the corresponding transcription and training replacement textual tokens for replacement of the one or more incorrect terms; and
training the assistant LLM based on the augmented plurality of training samples.

26. The system of claim 14, wherein the operations further comprise:
obtaining a plurality of training samples, each respective training sample comprising audio data characterizing a spoken utterance and paired with a corresponding transcription;
augmenting the plurality of training samples by, for each corresponding transcription of each respective training sample:
prompting an auxiliary LLM to generate a continuation output based on the corresponding transcription;
appending the continuation output to the corresponding transcription, and
inserting a training revision token between the corresponding transcription and the continuation output, the training revision token identifying a number of terms in the continuation output appended to the corresponding transcription and training replacement textual tokens for replacement of the one or more incorrect textual tokens; and
training the assistant LLM based on the augmented plurality of training samples.
